(19) United States
(12) Patent Application Publication
(10) Pub. No.: US 2024/0262249 A1
(43) Pub. Date: Aug. 8, 2024

(54) BATTERY MANAGEMENT DEVICE

(71) Applicant: DENSO CORPORATION, Kariya-city (JP)

(72) Inventors: Masanari NUMATA, Kariya-city (JP); Yu OFUNE, Kariya-city (JP); Yasuteru FUKUI, Kariya-city (JP); Nobuharu KAKEHASHI, Kariya-city (JP)

(21) Appl. No.: 18/610,616

(22) Filed: Mar. 20, 2024

Related U.S. Application Data
(63) Continuation of application No. PCT/JP2022/030697, filed on Aug. 11, 2022.

(30) Foreign Application Priority Data
Sep. 29, 2021 (JP) 2021-159156

(51) Int. Cl. B60L 58/24; B60L 15/20; B60L 58/12; H01M 10/42; H01M 10/625; H01M 10/63

(52) U.S. Cl. CPC B60L 58/24; B60L 15/20; B60L 58/12; H01M 10/425; H01M 10/625; H01M 10/63; B60L 2240/12; B60L 2240/545; B60L 2240/66; H01M 2010/4271; H01M 2220/20

(57) ABSTRACT

An energy manager serving as a battery management device manages a state of a driving battery mounted on a vehicle. The battery management device includes a temperature adjustment unit, an environmental information acquisition unit, a temperature estimation unit, a target temperature setting unit, and a travel speed adjustment unit. The target temperature setting unit sets a target battery temperature at which the battery can be efficiently charged by operating the temperature adjustment unit when the vehicle arrives at a charging facility. The travel speed adjustment unit uses battery temperature estimated by the temperature estimation unit and target battery temperature set by the target temperature setting unit to determine an adjustment amount of a travel speed when the vehicle travels to the charging facility.

### CROSS REFERENCE TO RELATED APPLICATION

The present application is a continuation application of International Patent Application No. PCT/JP2022/030697 filed on Aug. 11, 2022, which designated the U.S. and claims the benefit of priority from Japanese Patent Application No. 2021-159156 filed on Sep. 29, 2021. The entire disclosures of all of the above applications are incorporated herein by reference.

### TECHNICAL FIELD

The present disclosure relates to a battery management device that manages a driving battery mounted on a vehicle.

### BACKGROUND

Conventionally, a driving battery mounted on a vehicle is managed from various viewpoints in order to fully exhibit the capacity of the driving battery. For example, a battery management device is configured to adjust a temperature of the driving battery prior to charging at a charging facility, based on information about future travel to the charging facility.

### SUMMARY

A battery management device according to an aspect of the present disclosure is configured to manage a state of a driving battery mounted on a vehicle. The battery management device includes a temperature adjustment unit, an environmental information acquisition unit, a temperature estimation unit, a target temperature setting unit, and a travel speed adjustment unit.

The temperature adjustment unit is configured to perform a temperature adjustment of the battery. The environmental information acquisition unit is configured to acquire environmental information including information on a charging facility capable of charging the battery based on a charging plan in connection with a travel of the vehicle toward a destination in a future. The temperature estimation unit is configured to estimate a temperature of the battery when the vehicle arrives at the charging facility based on the environmental information acquired by the environmental information acquisition unit. The target temperature setting unit is configured to set a target temperature of the battery, at which an efficient charging of the battery is performable when the vehicle travels and arrives at the charging facility while operating the temperature adjustment unit. In addition, the travel speed adjustment unit is configured to determine an adjustment amount of a travel speed when the vehicle travels to the charging facility by using an estimated temperature of the battery estimated by the temperature estimation unit and the target temperature of the battery set by the target temperature setting unit.

### BRIEF DESCRIPTION OF THE DRAWINGS

The above object and other objects, features, and advantages of the present disclosure will become more apparent from the following detailed description with reference to the accompanying drawings. In the accompanying drawings:

FIG. 1 is a configuration diagram of a vehicle to which a battery management device of a first embodiment is applied;

FIG. 2 is a block diagram of a schematic configuration of an energy manager according to the first embodiment;

FIG. 3 is a flowchart of a battery management program according to the first embodiment;

FIG. 4 is an explanatory diagram of an example of a deceleration amount determination table in the first embodiment;

FIG. 5 is an explanatory diagram of an influence of a travel speed adjustment process on battery temperature according to the first embodiment;

FIG. 6 is an explanatory diagram of an influence of the travel speed adjustment process on a charging rate of the battery according to the first embodiment;

FIG. 7 is a flowchart of a battery management program according to a second embodiment;

FIG. 8 is an explanatory diagram of an influence of a travel speed adjustment process on battery temperature according to the second embodiment;

FIG. 9 is an explanatory diagram of an influence of a travel speed adjustment process on the charging rate of the battery according to the second embodiment;

FIG. 10 is an explanatory diagram of an example of a total required time in a first operation pattern according to a third embodiment;

FIG. 11 is an explanatory diagram of an example of the total required time in a second operation pattern according to the third embodiment; and

FIG. 12 is an explanatory diagram of an example of the total required time in a third operation pattern according to the third embodiment.

### EMBODIMENTS FOR CARRYING OUT THE INVENTION

When a battery management device is applied to a driving battery mounted on a vehicle, a state of the battery is also affected by a travel load of the vehicle. Even in a configuration in which temperature of the battery is adjusted in advance before charging the battery at the charging facility, temperature of the battery may be not adjustable to a target state depending on the influence of the travel load of the vehicle.

For example, if the travel load of the vehicle is too much, the amount of heat generated by the battery due to the travel load increases and may exceed a cooling capacity of a vehicle temperature adjustment unit, thereby making it impossible to cool the battery to a target state.

Further, if the travel load of the vehicle increases in a case where the vehicle travels at a high speed, the time for which the vehicle arrives to the charging facility may become shorter due to the high-speed travel. In such case, since a temperature adjustment time for adjusting the battery temperature due to the temperature adjustment unit is reduced, the battery may be difficult to be cooled to the target state.

If the battery cannot be cooled to the target state, a charging current at the charging facility may be limited in consideration of the influence of self-heating of the battery when charging at the charging facility. When the charging current is limited, a large amount of time may be required to charge the battery at the charging facility, thereby causing a large amount of loss time in such charging of the battery to complete.

In view of the above, it is an object of the present disclosure to provide a battery management device that manages a driving battery installed in a vehicle to effectively reduce the time required to complete charging at a charging facility.

A battery management device according to an exemplar of the present disclosure is configured to manage a state of a driving battery mounted on a vehicle. The battery management device includes a temperature adjustment unit, an environmental information acquisition unit, a temperature estimation unit, a target temperature setting unit, and a travel speed adjustment unit.

The temperature adjustment unit is configured to perform a temperature adjustment of the battery. The environmental information acquisition unit is configured to acquire environmental information including information on a charging facility capable of charging the battery based on a charging plan in connection with a travel of the vehicle toward a destination in a future. The temperature estimation unit is configured to estimate a temperature of the battery when the vehicle arrives at the charging facility based on the environmental information acquired by the environmental information acquisition unit. The target temperature setting unit is configured to set a target temperature of the battery, at which an efficient charging of the battery is performable when the vehicle travels and arrives at the charging facility while operating the temperature adjustment unit. In addition, the travel speed adjustment unit is configured to determine an adjustment amount of a travel speed when the vehicle travels to the charging facility by using an estimated temperature of the battery estimated by the temperature estimation unit and the target temperature of the battery set by the target temperature setting unit.

According to the battery management device, when the vehicle travels to the charging facility by operating the temperature adjustment unit, the travel speed of the vehicle moving toward the charging facility can be adjusted by the travel speed adjustment unit. By adjusting the travel speed, it is possible to ensure an appropriate operation time for the temperature adjustment unit. Thus, the temperature of the battery at a time of arriving to the charging facility can be adjusted to the target battery temperature, and a time required to complete the charging of the battery at the charging facility can be effectively reduced.

Hereinafter, embodiments for implementing the present disclosure will be described referring to drawings. In each embodiment, portions corresponding to those described in the preceding embodiment are denoted by the same reference numerals, and overlapping descriptions may be omitted. When only a part of a configuration is described in each embodiment, the other embodiments described above may be applied for the other parts of the configuration. The parts may be combined even if it is not explicitly described as combinable. The embodiments may be partially combined even if it is not explicitly described as combinable, provided there is no harm in the combination.

### First Embodiment

The first embodiment of the present disclosure will be described with reference to the drawings. In the first embodiment, a battery management device according to the present disclosure is used as an energy manager 1 mounted on a vehicle A.

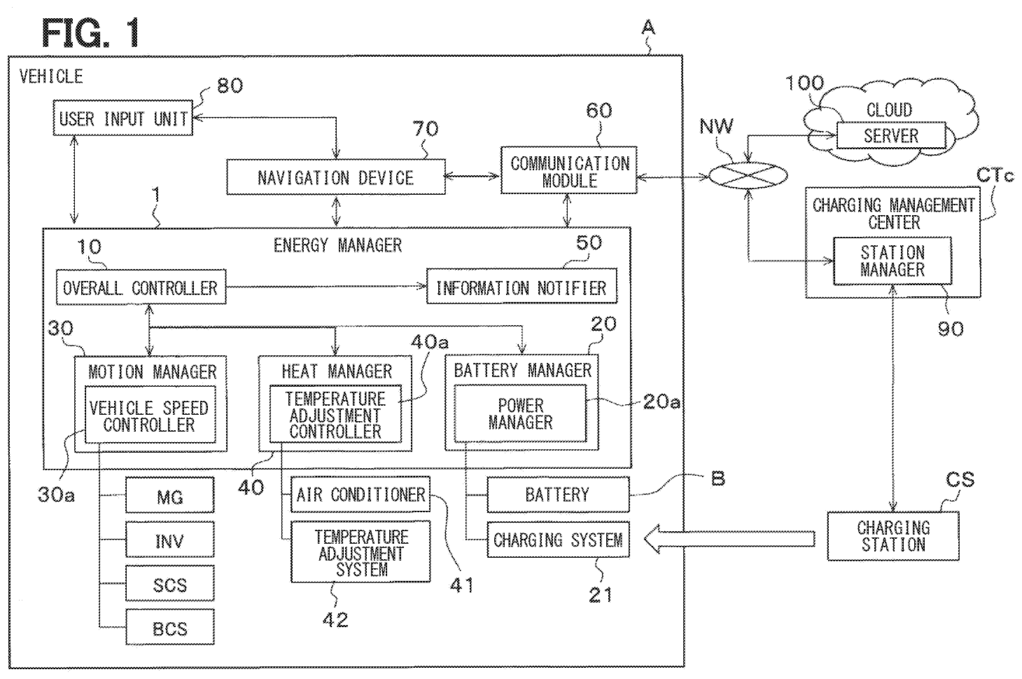

As shown in FIG. 1, the vehicle A is a BEV (Battery Electric Vehicle) that is equipped with a battery B for driving, and travels on the electric power of the battery B. The energy manager 1 includes an overall controller 10, a battery manager 20, a motion manager 30, a heat manager 40, and an information notifier 50, and manages a state of the battery B.

Here, the energy manager 1 is realized by an in-vehicle computer that includes a processing unit, a RAM, a storage unit, an input/output interface, a bus connecting these, and the like. The processing unit is hardware for arithmetic processing combined with RAM. The processing unit executes various processes to implement the functions of each functional unit, which will be described later, by accessing the RAM. The storage unit includes a nonvolatile storage medium. The storage unit stores various programs (such as a battery management program) executed by the processing unit. The specific configuration and each of the functional unit of the energy manager 1 will be explained in detail later.

The vehicle A is equipped with the energy manager 1, a communication module 60, a navigation device 70, a user input unit 80, a plurality of consumption domains DEc, a power supply domain DEs, a charging system 21, and the like.

The communication module 60 is a communication module (Data Communication Module) mounted on the vehicle A. The communication module 60 transmits and receives radio waves to and from base stations around the vehicle A through wireless communication in accordance with communication standards such as LTE (Long Term Evolution) and 5G. By having the communication module 60, the vehicle A becomes a connected car that can be connected to a network NW.

The communication module 60 can send and receive information to and from a cloud server 100, a station manager 90, etc. via network NW. The cloud server 100 is an information distribution server installed on a cloud, and distributes, for example, weather information, road traffic information, and the like.

The station manager 90 is a calculation system installed in a charging management center CTc. The station manager 90 is communicably connected to a large number of charging stations CS installed in a specific area through the network NW. The station manager 90 grasps station information about each of the charging stations CS. The station information includes an installation location of the charging station CS, usability information indicating whether or not it is in use, charging capacity information of a charger, and the like. The charging capacity information includes, for example, whether or not quick charging is possible, charging standard usable at the charger, maximum output for quick charging, and the like. The station information is an example of environmental information.

The charging station CS is an infrastructure facility that charges the driving battery B mounted on the vehicle A, and corresponds to charging facility. Each of the charging stations CS charges the battery B using AC power supplied through a power grid or DC power supplied from a solar power generation system or the like. The charging station CS is installed, for example, in parking lots of shopping malls, convenience stores, public facilities, and the like.

The navigation device 70 is an in-vehicle device that guides a travel route to a destination set by a user. The navigation device 70 provides guidance such as going straight, turning left or right, changing lanes, etc. at intersections, branch points, merge points, etc. by displaying a graphics on screen and playing audio. The navigation device 70 can provide the energy manager 1 with information such as a distance to the destination, a vehicle speed in each of route sections, and a difference in elevation as the navigation information and as the environmental information.

The user input unit 80 is an operation device that accepts input operations by a user who is an occupant of the vehicle A. The user input unit 80 receives inputs of, for example, a user operation to operate the navigation device 70, a user operation to switch between starting and stopping temperature adjustment control (described later), and a user operation to change various setting values related to the vehicle A and the like. The user input unit 80 can provide the energy manager 1 with input information based on the user operations.

As the user input unit 80, for example, a steering switch provided on a spoke part of a steering wheel, a switch and dial installed on a center console, etc., a voice input device for detecting driver's utterances, and the like are installed in the vehicle A. Further, a touch panel or the like of the navigation device 70 may function as the user input unit 80. Further, a user terminal such as a smartphone or a tablet terminal may function as the user input unit 80 by being connected to the energy manager 1 by wire or wirelessly.

The consumption domain is a group of in-vehicle devices that implement various vehicle functions by using electric power from the battery B and the like. One consumption domain includes at least one domain manager, and is constituted by a group of in-vehicle devices whose power consumption is managed by the domain manager. The plurality of consumption domains include a travel control domain and a temperature control domain.

The travel control domain is a consumption domain that controls the travel of the vehicle A. The travel control domain includes a motor generator MG, an inverter INV, a steering control system SCS, a brake control system BCS, and the motion manager 30.

The motor generator MG is a drive power source that generates a driving force for driving the vehicle A. The inverter INV controls power running and regeneration performed by the motor generator MG. The steering control system SCS controls steering of the vehicle A. The brake control system BCS controls braking force generated in the vehicle A.

During power running by the motor generator MG, the inverter INV converts DC power supplied from the battery B into three-phase AC power, and supplies it to the motor generator MG. The inverter INV can adjust the frequency, current, and voltage of the AC power, and controls the driving force generated by the motor generator MG. On the other hand, during regeneration by the motor generator MG, the inverter INV converts the AC power into the DC power, and supplies it to the battery B.

The motion manager 30 integrally controls the inverter INV, the steering control system SCS, and the brake control system BCS, and allows the vehicle A to travel in accordance with the driver's driving operations. The motion manager 30 functions as a domain manager of the travel control domain, and comprehensively manages power consumption by each of the motor generator MG, the inverter INV, the steering control system SCS, and the brake control system BCS.

The motion manager 30 also includes a vehicle speed controller 30a. The vehicle speed controller 30a controls a travel speed of the vehicle A by integrally controlling the inverter INV, the steering control system SCS, and the brake control system BCS.

The temperature control domain is a consumption domain that performs air conditioning of the compartment space of the vehicle A and temperature adjustment of the battery B. The temperature control domain includes an air conditioner 41, a temperature adjustment system 42, and the heat manager 40. For example, a plurality of air conditioners 41 may be installed in one vehicle A.

The air conditioner 41 is an electric-type vehicle air conditioner that uses electric power supplied from the battery B to heat, cool, and ventilate a compartment space. The air conditioner 41 includes a refrigeration cycle device, a blower fan, an electric heater, an indoor air conditioning unit, and the like. The air conditioner 41 can control a compressor, an electric heater, an indoor air conditioning unit, etc. of the refrigeration cycle device, and can generate warm air and cold air. The air conditioner 41 supplies generated warm air or cold air to the compartment space as conditioned air by operating a blower fan.

The temperature adjustment system 42 is a system that cools or heats the battery B. The temperature adjustment system 42 may cool or heat the motor generator MG, the inverter INV, etc. beside heating and cooling the battery B. The temperature adjustment system 42 maintains temperature of the electric drive system within a predetermined temperature range by circulating a heat medium heated or cooled by the air conditioner 41.

For example, the temperature adjustment system 42 includes a heat medium circuit, an electric pump, a radiator, a chiller, a liquid temperature sensor, and the like. The heat medium circuit is mainly composed of pipes installed to connect each of the components of the electric drive system such as the battery B, the motor generator MG, and the inverter INV. The electric pump circulates the heat medium filled in the piping of the heat medium circuit. The exhaust heat of the battery B transferred to the heat medium is released into the outside air by a radiator or released into a refrigerant of the air conditioner 41 by a chiller. The liquid temperature sensor measures temperature of the heat medium. Therefore, the temperature adjustment system 42 corresponds to an example of a temperature adjustment unit.

The heat manager 40 is an in-vehicle computer that controls an operation of the air conditioner 41 and the temperature adjustment system 42. The heat manager 40 compares a target air conditioning temperature of the compartment space with temperature measured by a temperature sensor installed in the compartment space, and controls the air conditioning operation of the air conditioner 41. Further, the heat manager 40 controls the temperature control operations of the air conditioner 41 and the temperature adjustment system 42 by referring to the measurement results obtained by the liquid temperature sensor.

That is, thermal manager 40 functions as a domain manager of thermal domain. The heat manager 40 has a temperature adjustment controller 40a, and the temperature adjustment controller 40a comprehensively manages consumption of electric power by each of the air conditioner 41 and the temperature adjustment system 42.

The power supply domain is a group of in-vehicle devices that enable supply of electric power to the consumption domain. The power supply domain, just like the consumption domain, includes at least one domain manager and includes a charging circuit, the battery B, and the battery manager 20.

The charging circuit functions as a junction box that integrally controls a flow of electric power between each of the consumption domains and the battery B in cooperation with the battery manager 20. The charging circuit supplies electric power from the battery B and charges the battery B.

The battery B is a secondary battery that can charge and discharge electric power. The battery B is constituted as an assembled battery including a large number of battery cells. As the battery cell, for example, a nickel-metal hydride battery, a lithium ion battery, an all-solid-state battery, or the like can be used. The electric power stored in the battery B can be used mainly for driving the vehicle A and for air-conditioning the compartment space.

The battery manager 20 is an in-vehicle computer that functions as a domain manager of the power supply domain. The battery manager 20 includes a power manager 20a, and manages electric power supplied from the charging circuit to each of the consumption domains. Further, the battery manager 20 notifies the overall controller 10 of the energy manager 1 of a remaining amount information about the battery B as environmental information.

The charging system 21 supplies electric power to the power supply domain, and allows the battery B to be charged. An external charger is electrically connected to the charging system 21 at a charging station CS. The charging system 21 outputs charging electric power supplied through a charging cable to the charging circuit.

When performing normal charging, the charging system 21 converts AC power supplied from a charger for normal charging into DC power, and supplies it to the charging circuit. On the other hand, when performing quick charging, the charging system 21 outputs DC power supplied from a charger for quick charging to the charging circuit. The charging system 21 has a function of communicating with a charger for quick charging, and controls a voltage supplied to the charging circuit in cooperation with a control circuit of the charger.

As shown in FIG. 1, the energy manager 1 according to the first embodiment includes the overall controller 10, the battery manager 20, the motion manager 30, the heat manager 40, and the information notifier 50. As described above, the battery manager 20, the motion manager 30, and the heat manager 40 are in-vehicle computers that control specific functions (for example, the vehicle's travel function and temperature control function), and serve a part of the energy manager 1.

Then, the overall controller 10 uses various information output from the battery manager 20, the motion manager 30, and the heat manager 40 to integrally manage usage of electric power by each of the consumption domains. The overall controller 10 is constituted as an in-vehicle computer, and constitutes a part of the energy manager 1. The overall controller 10 plays a key role in control processing in the energy manager 1.

The information notifier 50 is an in-vehicle computer that functions as a domain manager to notify information identified by using various information from the battery manager 20 or the like, and constitutes a part of the energy manager 1. A consumption domain for notifying information to the user of the vehicle A is connected to the information notifier 50. For example, a display and a speaker of the navigation device 70, a display unit disposed on an instrument panel at a forefront of the vehicle interior (i.e., an instrument panel), and the like are connected to the information notifier 50.

Thus, the information notifier 50 can display information identified by the overall controller 10 (for example, information related to recommended travel speeds described later) on a display of the navigation device 70 or the like. Further, the information notifier 50 can output the information identified by the overall controller 10 in audio form from the speaker of the navigation device 70. The display, speaker, etc. of the navigation device 70 correspond to an example of an information transmission unit.

Supply of electric power supplied to the energy manager 1, which is an in-vehicle computer, is continued even when the vehicle A is in a non-drivable state (for example, having an ignition switch of the vehicle A being turned off). Therefore, even during a leaving period, i.e., a vehicle non-use period, the energy manager 1 can activate each functional unit and execute predetermined processing if control execution is required.

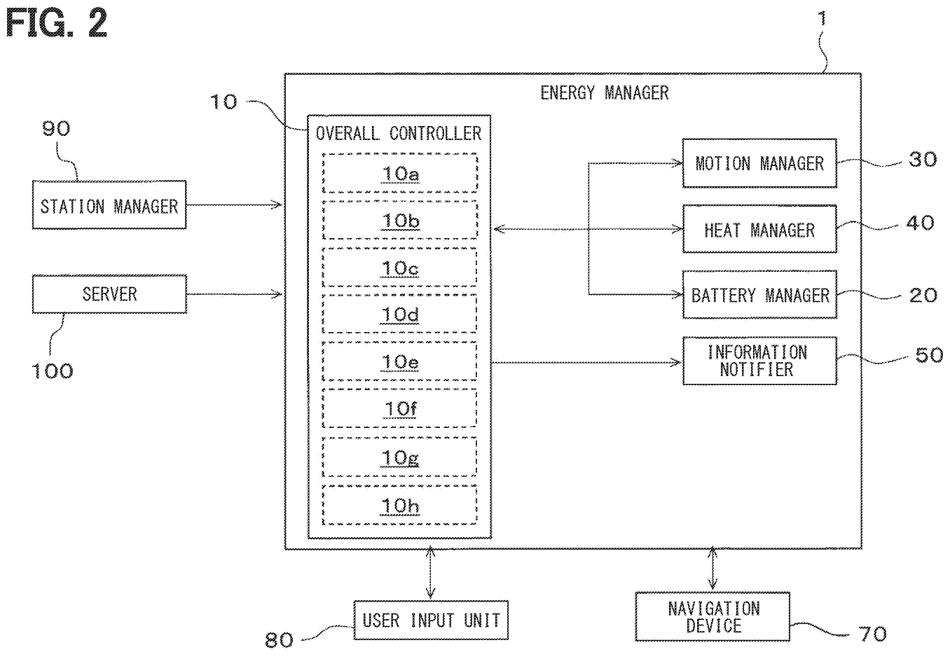

Here, in the overall controller 10 of the energy manager 1, a control unit that controls various control target devices connected as a consumption domain and a power supply domain is integrally configured. As shown in FIG. 2, in the overall controller 10, the configuration (hardware and software) that controls the operation of each device to be controlled constitutes a control unit that controls the operation of each device to be controlled.

For example, in the overall controller 10, a configuration for acquiring environmental information including information regarding (a) the travel route on which the vehicle A will travel in the future toward the destination, and (b) a charging facility (i.e., the charging station CS) that is placed on the travel route and is capable of charging the battery B corresponds to the environmental information acquisition unit 10a.

The environmental information includes information that affects the state of battery B at the destination of the vehicle A. As the destination, a parking area or a waiting area where the vehicle A is left, a charging station CS, or the like can be determined. The state of the battery B is, for example, the remaining amount and temperature.

The environmental information includes information provided from outside the vehicle A, that is, for example, center information distributed from the station manager 90, the cloud server 100, and the like. The center information includes usability information and charging capacity information regarding the charger of the charging station CS. Further, the environmental information includes weather information, road traffic information, and the like. The weather information includes information indicating the outside temperature, the amount of solar radiation, the amount of radiant heat from the road surface, and the presence or absence of rain or snow on the travel route set in the navigation device 70.

Further, the environmental information includes information generated inside the vehicle A among information that affects the state of the battery B. For example, information provided by the navigation device 70, the power supply domain, the consumption domain, and the like corresponds to an example of environmental information. The information provided by the navigation device 70 includes information such as the number of traffic lights (number of stops), in addition to the distance to the destination, the vehicle speed in each section, and the height difference.

Among the environmental information, the information provided from the power supply domain includes status information indicating the state of the power supply domain. The status information includes remaining amount information, i.e., information on the remaining amount of the battery B, temperature information, and the like. The remaining amount information includes, for example, a value of the charging rate (State of Charge).

Further, the information provided by the motion manager 30 includes, for example, information indicating the driving tendency of the driver, and specifically includes at least information indicating the tendency of the driver's accelerator opening degree and brake pedal force.

Information provided from the user input unit 80 may also be acquired as environmental information. In such case, the information may be input to the user input unit 80 by a user on the vehicle A, or may be information input to a user terminal functioning as the user input unit 80 by a user outside the vehicle A. Further, the information may be information input by the user in real time in response to an inquiry from a system side such as the energy manager 1, or may be information indicating setting values recorded by the user's past operations.

Further, among the environmental information, information provided from the consumption domain can include the status information indicating the status of each of the consumption domains. For example, the status information includes (a) air conditioning information indicating set temperature of the air conditioning in the compartment space (hereinafter referred to as “air conditioning request information”) and current temperature, (b) temperature information of the heat medium in the heat medium circuit, (c) the status of the motor generator MG and inverter INV (e.g., information indicating current temperature, etc.).

The environmental information is not limited to information including current actual measured values, but may include information including future estimated values. Specifically, a usage schedule can be set for the vehicle A regarding the use in the future. The usage schedule includes a travel schedule after vehicle A is left unused, a high load travel schedule, a charging schedule, a travel schedule after the battery B is left in a high temperature state, a travel schedule after the battery B is left in a low temperature state, and the like.

As shown in FIG. 2, among the configurations of the overall controller 10, a configuration that estimates battery temperature Tb of the battery B when the vehicle A arrives at the charging station CS based on the environmental information acquired by the environmental information acquisition unit 10a corresponds to a temperature estimation unit 10b. Specifically, the temperature estimation unit 10b uses information regarding the travel route provided from the navigation device 70, the center information provided from the station manager 90, the weather information and the road traffic information provided from the cloud server 100, to estimate the battery temperature Tb.

Further, among the configurations of the overall controller 10, a configuration that sets a target battery temperature TbO at which the battery B can be efficiently charged when the vehicle A arrives at a predetermined charging station CS by a travel during which the temperature of the battery B is adjusted corresponds to a target temperature setting unit 10c.

Here, it is known that when the battery B is charged at the charging station CS, the battery B self-generates heat by receiving supply of electric power at the charging station CS. If the battery temperature Tb becomes too high, it will cause deterioration of the battery B itself, so if it becomes higher than a predetermined battery temperature upper limit value TbU, a magnitude of the charging current supplied from the charging station CS is controlled to be lower than normal.

In such case, since the charging current is suppressed to a low level, a charging time required to charge the battery B at the charging station CS becomes longer than in a normal state where the battery temperature is lower than the battery temperature upper limit value TbU, and the efficiency of charging the battery B lowers.

The target temperature setting unit 10c sets the target battery temperature TbO so that that the battery temperature Tb at the time of completion of charging of the battery B is equal to or lower than the battery temperature upper limit value TbU based on a relationship between (a) an increase in the battery temperature Tb due to charging and (b) the battery temperature upper limit value TbU set for the battery B.

Further, among the configurations of the overall controller 10, a configuration that adjusts the travel speed of the vehicle A when the vehicle A travels to the charging facility of the charging station CS using (a) the estimated battery temperature Tb upon arrival at the charging station CS and (b) the target battery temperature TbO corresponds to a travel speed adjustment unit 10d.

As described above, when traveling toward the charging station CS, the temperature of the battery B is adjusted by the temperature adjustment system 42, and at the same time, the electric power stored in the battery B is output. That is, during the travel to the charging station CS, the battery temperature Tb increase due to the vehicle A travels, and a cooling adjustment of the battery temperature Tb by using the temperature adjustment system 42 are performed in parallel.

It is considered that the greater the travel load of vehicle A is, the greater the rise in the battery temperature Tb associated with such travel becomes. Therefore, if the travel load of the vehicle A is greater than the cooling capacity of the temperature adjustment system 42, the battery B cannot be sufficiently cooled by the temperature adjustment system 42, and it is assumed that the battery temperature Tb upon arrival at the charging station CS will be higher than the target battery temperature TbO.

The travel speed adjustment unit 10d adjusts the travel load of the vehicle A, and at the same time adjusts the travel speed of a travel toward the charging station CS in order to ensure a period during which temperature adjustment of the battery B is performed by the temperature adjustment system 42. The travel speed is adjusted by the travel speed adjustment unit 10d so that at least the battery temperature Tb upon arrival at the charging station CS is lower than the target battery temperature TbO.

Then, among the configurations of the overall controller 10, a configuration that estimates the time required for the vehicle A to arrive at the predetermine charging station CS, by operating the temperature adjustment system 42 based on the acquired environmental information, and corresponds to a required time estimation unit 10e.

Further, among the configurations of the overall controller 10, a configuration that estimates the charging time when the vehicle A arrives at the charging station CS based on various environmental information corresponds to a charging time estimation unit 10f. The charging time estimation unit 10f estimates (a) a charging time when arriving at the charging station CS at the current travel speed, and (b) a charging time when arriving at the charging station CS while traveling at the travel speed adjusted by the travel speed adjustment unit 10d.

The charging time estimation unit 10f uses information regarding the travel route, the center information, the weather information, the road traffic information, the remaining amount information of the battery B, and the like to estimate the remaining amount information of the battery B at the time of arrival at the charging station CS when traveling at the current travel speed. Then, the charging time estimation unit 10f estimates the charging time at the arrived charging station CS based on the information on the arrived charging station CS and the remaining amount information of the battery B at the time of arrival.

Similarly, the charging time estimation unit 10f estimates the remaining amount information of the battery B when speed adjustment is performed, by using information on the travel speed adjusted by the travel speed adjustment unit 10d, in addition to information regarding the travel route, the center information, the weather information and the road traffic information, and the information on the remaining amount of the battery B, and the like. Then, the charging time estimation unit 10f estimates the charging time when the travel speed is adjusted based on the information on the charging station CS and the remaining amount information of the battery B.

Then, among the configurations of the overall controller 10, a configuration that estimates (a) a total time required to complete charging of the battery B when the vehicle A travels at the current travel speed and (b) a total time when the vehicle A travels at the travel speed adjusted by the travel speed adjustment unit 10d corresponds to a total time estimation unit 10g.

The total time estimation unit 10g estimates the total times of travel (a) when traveling at the current travel speed and (b) when adjustment of the travel speed by the travel speed adjustment unit 10d is performed by performing an addition of the required time and charging time estimated by the required time estimation unit 10e and the charging time estimation unit 10f.

The total time when traveling at the current speed is the sum of the required time and the charging time, which is estimated on an assumption that the vehicle A travels at the current speed. The total time when the travel speed is adjusted by the travel speed adjustment unit 10d is the sum of the required time and the charging time, which is estimated on an assumption that the travel speed is adjusted by the travel speed adjustment unit 10d.

Further, among the configuration of the overall controller 10, a configuration that adjusts a temperature adjustment capacity of the temperature adjustment system 42 in case that (a) a condition for adjusting the travel speed of the vehicle A by the travel speed adjustment unit 10d is being satisfied, and (b) the temperature adjustment capacity of the temperature adjustment system 42 is adjustable corresponds to a temperature adjustment capacity adjustment unit 10h. The temperature adjustment capacity adjustment unit 10h adjusts the temperature adjustment capacity of the temperature adjustment system 42 so that the battery temperature Tb when the vehicle A arrives at the charging station CS becomes the target battery temperature TbO.

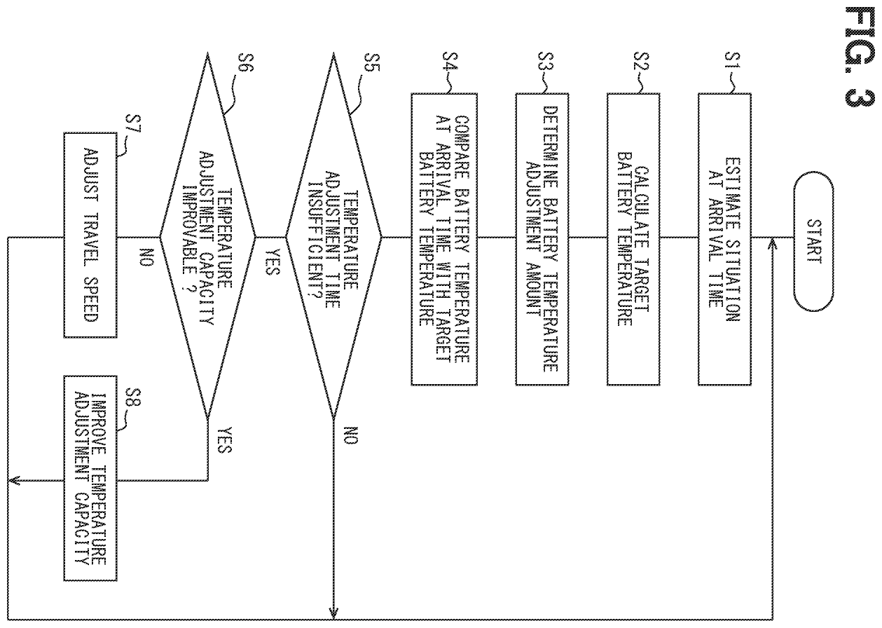

Next, the processing contents of the battery management program according to the first embodiment will be explained with reference to FIGS. 3 to 6. The battery management program according to the first embodiment is executed to reduce the charging time required to charge the battery B at charging station CS as much as possible when the vehicle A travels while adjusting the temperature of the battery B by the temperature adjustment system 42.

As described above, the battery management program according to the first embodiment is stored in the storage unit of the energy manager 1, and is read out and executed by the overall controller 10 that constitutes the processing unit. In the following description, it is assumed that a destination for the travel of the vehicle A is set, and that the navigation device 70 determines a travel route from the current location to the destination. It is further assumed that the travel route set by the navigation device 70 includes at least the charging station CS.

As shown in FIG. 3, first, in step S1, an arrival time situation at the time when vehicle A will arrive at the charging station CS is estimated using the environmental information acquired from the navigation device 70, the cloud server 100, and the like. For example, the charging rate (the remaining amount information) of the battery B at the time of arrival at the charging station CS can be estimated by referring to the current remaining amount information of the battery B, the road traffic information, the weather information, and the like as the environmental information. Further, the battery temperature Tb at the time of arrival at the charging station CS is determined by referring to the current battery temperature Tb, the road traffic information, the weather information, an internal resistance of the battery B, temperature adjustment capacity of the temperature adjustment system 42, and the like as the environmental information. After identifying the situation of the battery B and the like at the time of arrival at the charging station CS using the environmental information, the process proceeds to step S2.

The temperature control capability of the temperature adjustment system 42 in such case can be limited within a predetermined standard capacity range. Specifically, the temperature adjustment capacity of the temperature adjustment system 42 is limited by the maximum capacity of the components of the refrigeration cycle device, and is also limited by the upper limit value of the rotation speed of the compressor.

In step S2, the target battery temperature TbO at the charging station CS related to an arrival time situation in step S1 is calculated. The target battery temperature TbO is determined so that the battery temperature Tb becomes lower than a battery temperature upper limit value TbU determined for the battery B while the battery B is being charged at the charging station CS.

That is, the target battery temperature TbO is determined in consideration of self-heating of the battery B due to charging at the charging station CS so that the battery temperature Tb becomes equal to or lower than the battery temperature upper limit value TbU at the time of completion of the charging. When calculating the target battery temperature TbO, for example, a planned charging amount of the battery B at the charging station CS, the center information including the rating of the charger at the charging station CS, information indicating the internal resistance of the battery B, and the like are usable as the environmental information.

In step S3, a battery temperature adjustment amount required for the battery temperature Tb at an arrival time at the charging station CS to become the target battery temperature TbO when the vehicle travels to the charging station CS at the current travel speed is calculated. When calculating the battery temperature adjustment amount, the amount of heat generated by the battery B due to the travel of the vehicle A and the temperature control capability of the temperature adjustment system 42 can be estimated as approximate numerical values. Therefore, in order to cool the battery to the target battery temperature TbO, it is possible to specify the execution period of temperature adjustment by the temperature adjustment system 42.

In step S4, the battery temperature at the arrival time estimated in step S1 is compared with the target battery temperature TbO calculated in step S2. By comparing the battery temperature at the arrival time and the target battery temperature TbO, it is determined whether a temperature adjustment execution time by the temperature adjustment system 42 until arriving at the charging station CS is sufficient to reach the target battery temperature TbO.

In step S5, it is determined whether or not the temperature adjustment system 42 has insufficient temperature adjustment execution time to perform temperature control based on the comparison result between the battery temperature at the arrival time and the target battery temperature TbO in step S4.

If the battery temperature at the arrival time is higher than the target battery temperature TbO, it means that the battery B has not been cooled down to the target battery temperature TbO, so it can be determined that the temperature adjustment execution time is insufficient. If it is determined that the temperature adjustment execution time is insufficient, the process proceeds to step S6. On the other hand, if the battery temperature at the arrival time is equal to or lower than the target battery temperature TbO, it means that the temperature adjustment execution time is sufficient, and the process returns to step S1.

In step S6, it is determined whether the temperature adjustment capacity of the temperature adjustment system 42 is improvable. As mentioned above, the temperature adjustment capacity of the temperature adjustment system 42 is usually limited by the maximum capacity defined for the components of the refrigeration cycle device, for example, by the maximum rotation speed of the compressor.

The maximum rotation speed of the compressor is often determined for quality assurance purposes, and it may be possible to operate the compressor at a rotation speed higher than the maximum value for a short period of time. In other words, it is possible to temporarily improve the temperature adjustment capacity of the temperature adjustment system 42 by operating the compressor at a rotation speed higher than the maximum value, even though such an operation should be limited for a short period of time.

Thus, in step S6, it is also determined whether or not the battery temperature at the arrival time becomes equal to or lower than the target battery temperature TbO by temporarily improving the temperature adjustment capacity of the temperature adjustment system 42. If the battery temperature at the arrival time even in such case is higher than the target battery temperature TbO, the process proceeds to step S7, and otherwise, the process proceeds to step S8.

In step S7, the travel speed of the vehicle A when heading from the current location to the charging station CS is adjusted so that the battery temperature at the arrival time becomes the target battery temperature TbO. Specifically, in step S7, the travel speed is adjusted based on a deceleration amount determination table stored in the storage unit of the energy manager 1. The overall controller 10 that executes the process in step S7 functions as a travel speed adjustment unit 10d.

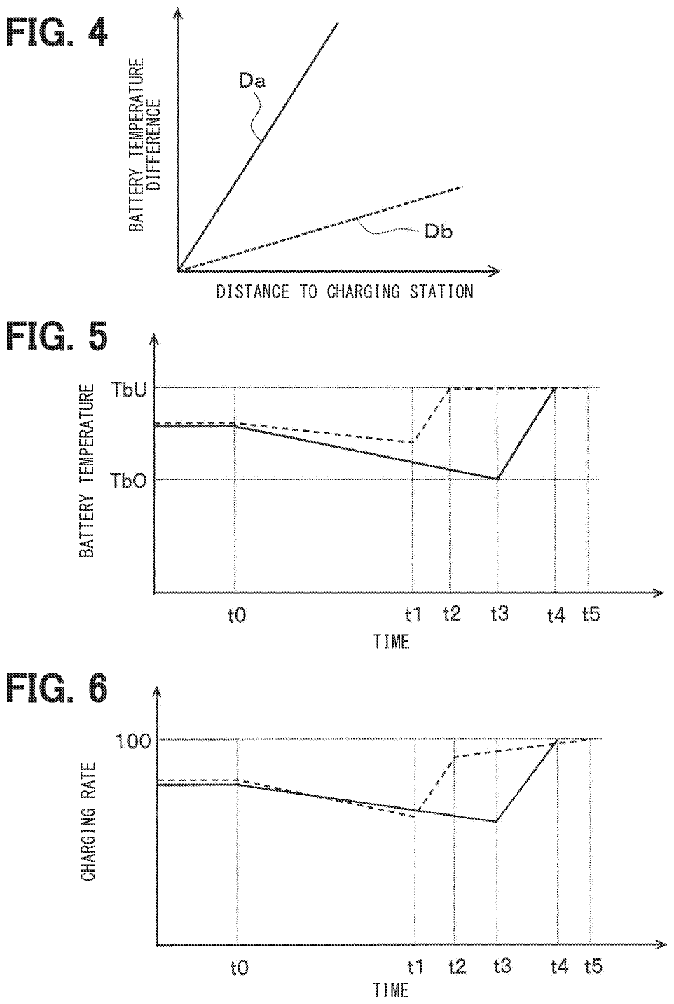

As shown in FIG. 4, the deceleration amount determination table is configured by associating (a) the amount of deceleration of the travel speed with (b) a battery temperature difference and a distance to the charging station CS. The battery temperature difference means a value obtained by subtracting the target battery temperature TbO from the battery temperature at the arrival time, and is the amount of deviation of the battery temperature at the arrival time from the target battery temperature TbO. The distance to the charging station CS means the distance from the current location to the charging station CS. The distance to the charging station CS can be replaced with the time it takes to arrive at the charging station CS.

In the deceleration amount determination table, a line Db indicating a standard amount of deceleration and a line Da indicating an even larger amount of deceleration are defined, both of which defines that greater an amount of deceleration is for longer a distance to the charging station and greater the battery temperature difference become. The greater the deviation (battery temperature difference) between the battery temperature at the arrival time and the target battery temperature TbO is, the larger the amount of deceleration of the travel speed is determined, thereby the time required for a travel from the current location to the charging station CS can be lengthened. As a result, it is possible to lengthen the temperature adjustment execution time during which the temperature adjustment system 42 performs the temperature adjustment of the battery B, thereby making it possible to bring the battery temperature at the arrival time to the target battery temperature TbO.

Then, in step S7, the currently-set target value of the travel speed is updated using a determined deceleration amount of the travel speed. Specifically, the determined deceleration amount is subtracted from the currently-set target value of the travel speed, and the result is set as a new target value of the travel speed.

At this time, the newly-set target value of the travel speed may be notified to the user via information notifier 50. Various methods such as image output and audio output can be used to notify the user of such value. For example, the information regarding the target value of the travel speed may be displayed on the display of the navigation device 70, or the information regarding the target value of the travel speed may be output as a voice via audio system installed in the vehicle A.

In step S7, by adjusting the travel speed to ensure a temperature adjustment execution time, it is possible to control the battery temperature Tb at the arrival time at the charging station CS to become the target battery temperature TbO. As a result, even if the battery B is charged at the charging station CS, the battery temperature Tb will not exceed the battery temperature upper limit value TbU, and the battery B can be charged while fully utilizing the capacity of the charging station CS. In other words, the capacity of the charging station CS can be fully utilized, and the charging time of the battery B at the charging station CS is reducible.

Then, in step S8, the temperature adjustment capacity of the temperature adjustment system 42 performed between the current location and the charging station CS is adjusted. By improving the temperature adjustment capacity (cooling capacity) of the temperature adjustment system 42, the battery temperature of the battery B is adjusted by the temperature adjustment system 42 so that the battery temperature at the arrival time becomes the target battery temperature TbO even when the temperature adjustment execution time is insufficient. The overall controller 10 that executes step S8 functions as the temperature adjustment capacity adjustment unit 10h.

Even in such case, even if the battery B is charged at the charging station CS, the battery temperature Tb will not exceed the battery temperature upper limit value TbU, thereby the battery B can fully utilize the capacity of the charging station CS. In other words, the capacity of the charging station CS can be fully utilized, and the charging time of the battery B at the charging station CS is reducible.

Next, the effects of the battery management program according to the first embodiment will be explained with reference to FIGS. 5 and 6. FIG. 5 shows an influence of whether or not the travel speed is adjusted on the change in the battery temperature Tb, in which a broken line indicates the battery temperature Tb when the travel speed is not adjusted, and a solid line indicates the battery temperature Tb when the travel speed is adjusted. FIG. 6 shows an influence that the presence or absence of the travel speed adjustment has on the change in charging rate, in which a broken line indicates the charging rate of the battery B when the travel speed is not adjusted, and a solid line indicates the battery temperature Tb when the travel speed is adjusted.

Further, time t0 to time t5 in FIGS. 5 and 6 indicate the same time. Time t0 indicates a start point of control by the battery management program according to the first embodiment, and control is performed with t0 as the current time.

First, changes in the battery temperature Tb and the charging rate of the battery B when the travel speed adjustment is not performed will be described. When control is started at time t0, the vehicle A travels to the charging station CS, and at the same time, the battery B is cooled by the temperature adjustment system 42.

At this time, the battery B self-generates heat due to the output caused by the travel of the vehicle A, and is cooled by the temperature adjustment system 42. At the same time, the battery temperature Tb decreases as the vehicle A travels toward the charging station CS. As shown by the broken line in FIG. 6, the charging rate of the battery B also decreases as the vehicle A travels toward the charging station CS due to the output associated with the travel of the vehicle A and the output associated with the operation of the temperature adjustment system 42.

Time t1 indicates a point in time when the vehicle A arrives at the charging station CS and charging at the charging station CS is started when the travel speed is not adjusted. As shown by the broken line in FIG. 5, when the travel speed is not adjusted, the temperature adjustment execution time is insufficient, thereby the battery temperature Tb at time t1 (i.e., battery temperature at the arrival time) is higher than the target battery temperature TbO.

At time t1, when charging of the battery B at the charging station CS is started, the charging rate of the battery B increases as shown in FIG. 6. At this time, as shown in FIG. 5, due to the supply of charging current to the battery B and the internal resistance of the battery B, the battery temperature Tb also rises as the charging time passes.

Time t2 indicates a point in time when the battery temperature Tb reaches the battery temperature upper limit value TbU due to charging at the charging station CS. At this time, as can be seen from the broken line in FIG. 6, the change in the charging rate of the battery B shows a different slope before and after the battery temperature Tb reaches the battery temperature upper limit value TbU, among which the slope of the charging rate after reaching the battery temperature upper limit value TbU becomes gentler. This is because the charging current supplied by the charging station CS is limited so that the battery temperature Tb of the battery B does not exceed the battery temperature upper limit value TbU.

Thus, from time t2 to time t5, the charging rate per unit time increases more slowly than from time t1 to time t2. Further, it can be seen that the charging time from time t1 to time t5 is required until the charging rate of the battery B reaches 100% at time t5.

Next, changes in the battery temperature Tb and the charging rate of the battery B when the travel speed is adjusted to reduce the speed will be explained. When the control is started at time t0, the vehicle A travels to the charging station CS, and at the same time, the battery B is cooled by the temperature adjustment system 42, similarly to the case where the travel speed is not adjusted.

At this time, as can be seen from the solid line and broken line in FIG. 5, the lowering rate of the battery temperature Tb during a travel toward the charging station CS is greater in case of performing the travel speed adjustment control for decreasing the speed, than in case of not performing the same. This is because the output of the battery B is reduced as the vehicle A travels by performing the travel speed adjustment control to reduce the speed, and the temperature adjustment system 42 can efficiently cool the battery B.

When the travel speed adjustment control is performed to reduce the speed, the vehicle does not arrive at the charging station CS at time t2, but arrives at the charging station CS at time t3. As shown by the solid line in FIG. 5, when the travel speed adjustment control is performed to decelerate, the vehicle A arrives at the charging station CS at time t3, and the battery temperature Tb at the arrival time indicates the target battery temperature TbO.

At time t3, when charging of the battery B at the charging station CS is started, the charging rate of the battery B increases as shown by the solid line in FIG. 6. At this time, as shown by the solid line in FIG. 5, the battery temperature Tb also rises as the charging time elapses due to the supply of the charging current to the battery B and the internal resistance of the battery B.

Here, the target battery temperature TbO at time t3 is determined so that the battery temperature Tb at the time of completion of charging (for example, the time when the charging rate reaches 100%) is equal to or lower than the battery temperature upper limit value TbU. Therefore, changes in the battery temperature Tb and the charging rate after time t3 are constant in the most efficient state.

Then, as shown by the solid line in FIG. 6, at time t4, the charging rate of the battery B reaches 100%, and charging of the battery B is completed. As described above, at time t4, the battery temperature Tb is equal to or lower than the battery temperature upper limit value TbU.

According to the above-described example, when the travel speed is not adjusted, the charging time of the battery B at the charging station CS is from time t2 to time t5. On the other hand, when the travel speed is adjusted to decelerate, even though the arrival at the charging station CS and the start of charging are cause at time t3, which is later than time t2 at which the same is caused when the travel speed is not adjusted, the charging time is, from time t3 to time t4.

That is, according to the energy manager 1 according to the first embodiment, by adjusting the travel speed using the battery management program, efficient charging of the battery B at the charging station CS is realized, and the charging time at the charging station CS is reducible.

As explained above, according to the energy manager 1 according to the first embodiment, when the vehicle A travels to the charging station CS while operating the temperature adjustment system 42, in step S7, the travel speed toward the charging station CS can be adjusted. By adjusting the travel speed, the operation time of the temperature adjustment system 42 can be appropriately ensured, thereby the battery temperature at the arrival time at the charging station CS can be adjusted to the target battery temperature TbO. Thereby, the charging capacity at the charging station CS can be efficiently utilized, so that the time required to complete charging of the battery B at the charging station CS is reducible.

Further, according to the energy manager 1, as shown in FIG. 4, the adjustment amount of the travel speed for traveling to the charging station CS is determined according to the battery temperature difference caused by the difference between the battery temperature at the arrival time and the target battery temperature TbO. Thereby, the travel time and the operation time of the temperature adjustment system 42 that ensures the operation time of the temperature adjustment system 42 required for the battery temperature Tb at the arrival time at the charging station CS to reach the target battery temperature TbO are identifiable, thereby enabling determination of the appropriate amount of adjustment.

Further, as shown in FIG. 4, the adjustment amount of the travel speed for traveling to the charging station CS is determined using the deceleration amount determination table that associates the battery temperature difference with the distance to the charging station CS. The distance to the charging station CS corresponds to the time required to reach the charging station CS. Therefore, the energy manager 1 can more appropriately determine the travel speed adjustment amount, and can more reliably reduce the charging time at the charging station CS.

Further, as shown in FIG. 4, the adjustment amount of the travel speed is determined so that the longer the distance to the charging station CS corresponding to the time required to reach the charging station CS is, the greater the speed reduction becomes. As a result, the travel speed will be appropriately adjusted according to the time required to reach the charging station CS and the distance to the charging station CS, thereby the charging time at the charging station CS is more reliably reducible.

Further, as shown in FIG. 4, the travel speed adjustment amount is determined so that the greater the battery temperature difference, which indicates that the degree of deviation between the battery temperature at the arrival time and the target battery temperature TbO is, the greater the speed reduction becomes. In such manner, the travel speed is appropriately adjusted according to the deviation between the battery temperature at the arrival time and the target battery temperature, thereby more reliably reducing the charging time at the charging station CS.

Further, according to the energy manager 1, the adjustment result of the travel speed is transmitted to the user via information notifier 50 in step S7. Thus, the user can grasp information regarding the travel speed to the charging station CS, thereby being enabled to perform driving operations based on the adjustment results.

Further, according to the energy manager 1, in step S7, the result of adjusting the travel speed can be set as a target value of control regarding the travel speed to the charging station CS. In such manner, the control related to traveling to the charging station CS becomes suitable for the reduction of the charging time, thereby enabling efficient charging at the charging station CS.

Further, according to the energy manager 1, in step S8, the temperature adjustment capacity (cooling capacity) of the temperature adjustment system 42 is improvable regarding the temperature control to be performed by the temperature adjustment system 42 from the current location to the charging station CS. Thereby, the battery temperature at the arrival time can be adjusted to the target battery temperature TbO without adjusting the travel speed of the vehicle A. In other words, the energy manager 1 can reduce the charging time at the charging station CS from a viewpoint of temperature adjustment capacity of the temperature adjustment system 42.

### Second Embodiment

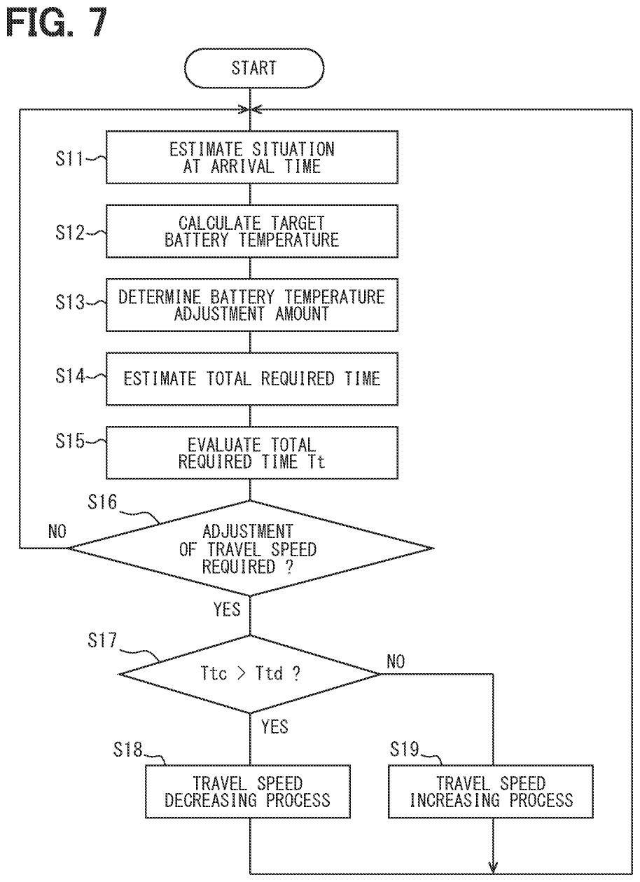

Next, portions of the second embodiment, different from the above-described first embodiment, will be described with reference to FIGS. 7 to 9. In the second embodiment, a battery management program is executed for the purpose of reducing not only the charging time at a charging station CS but also for reducing a total required time Tt including the time required from the current location to the charging station CS. Other than the above, the basic configuration of the energy manager 1 and the like are the same as those in the above-described embodiment, so a repeated explanation will be omitted. Here, the total required time Tt corresponds to an example of the total time.

The processing contents of the battery management program according to the second embodiment will be explained with reference to FIGS. 7 to 9. The battery management program according to the second embodiment is executed for reducing the total required time from the current moment to the completion of charging at the charging station CS when a vehicle A travels while adjusting the temperature of a battery B by the temperature adjustment system 42.

The total required time Tt is calculated as the sum of the time required to travel from the current moment to the charging station CS and the charging time required to charge the battery B at the charging station CS. Further, the prerequisites for executing the battery management program according to the second embodiment are the same as those in the first embodiment, and therefore will not be described again.

As shown in FIG. 7, in step S11, a situation at the time when the vehicle A arrives at the charging station CS is estimated using environmental information acquired from a navigation device 70, a cloud server 100, and the like. That is, in step S11, the same process as step S1 in the first embodiment is performed.

In step S12, a target battery temperature TbO at the charging station CS related to the arrival time situation in step S11 is calculated. The contents of the processing for calculating the target battery temperature TbO is the same as that in step S1 in the first embodiment, and therefore will not be described again.

In step S13, the battery temperature adjustment amount required for bringing the battery temperature Tb to the target battery temperature TbO at the arrival time at the charging station CS when the vehicle has traveled to the charging station CS at the current travel speed is determined. The processing contents of step S13 is the same as that of step S3 described above.

In step S14, first, the total required time Tt when traveling to the charging station CS at the currently-determined travel speed is estimated. The time required to arrive at the charging station CS from the current location when traveling at the current speed is estimated by using map information provided from the navigation device 70, road traffic information provided from the cloud server 100, and the like. Then, the charging time at the charging station CS when traveling at the current travel speed is identified using the remaining amount information of the battery B related to the arrival time situation identified in step S11 and the information on the charging station CS included in the center information. By summing the required time related to the current travel speed and the charging time determined in such manner, the total required time Tt (hereinafter referred to as a reference total required time Ttc) related to the current travel speed is determinable.

Subsequently, the total required time Tt (hereinafter referred to as a with-deceleration total required time Ttd) when the vehicle travels at a set decelerated from the currently-determined travel speed is estimated. The energy manager 1 estimates the with-deceleration required time for travel and the with-deceleration charging time, assuming that the vehicle travels at a speed that is decelerated by a predetermined value from the current speed.

The with-deceleration required time is estimated by using the travel speed during deceleration which is determined based on the currently-set travel speed, the map information provided from the navigation device 70, the road traffic information provided from the cloud server 100, and the like. The with-deceleration charging time can be identified by using the information on the remaining amount of the battery B at the arrival time at the charging station CS in the deceleration setting and the information on the charging station CS included in the center information. The remaining amount information in the deceleration setting can be estimated by the same method as in step S11 described above, except that the assumption of the travel speed is different. By summing the required time for the with-deceleration travel speed thus determined and the charging time, the with-deceleration total required time Ttd is determinable.

Further, the total required time Tt (hereinafter referred to as a with-acceleration total required time Tta) when the vehicle travels at an increased speed from the currently-set travel speed is estimated. The energy manager 1 estimates the with-acceleration required time and the with-acceleration charging time, assuming that the travel speed is increased by a predetermined value from the currently-set travel speed.

The with-acceleration required time is estimated based on the currently-set travel speed, the map information provided by the navigation device 70, the road traffic information provided by the cloud server 100, and the like. Then, the with-acceleration charging time can be identified using the remaining amount information of the battery B at the arrival time at the charging station CS in the speed increase setting and the information on the charging station CS included in the center information. The remaining amount information in the speed increase setting can be estimated by the same method as in step S11 described above, except that the assumption of the travel speed is different. By summing the thus determined required time and the charging time related to the increased travel speed, the with-acceleration total required time Tta is determinable. After estimating the reference total required time Ttc related to the current travel speed, the with-deceleration total required time Ttd, and the with-acceleration total required time Tta, the process proceeds to step S15.

In step S15, the reference total required time Ttc, the with-deceleration total required time Ttd, and the with-acceleration total required time Tta estimated in step S14 are compared to evaluate the setting of the travel speed from the current location to the charging station CS. That is, one of the three types of travel speed settings is identified, for the shortest total required time Tt, which completes the charging of the battery B at an earliest timing.

In step S16, it is determined whether adjustment of the travel speed is required by using the evaluation result in step S15. That is, it is determined whether the reference total required time Ttc is longer than the with-deceleration total required time Ttd or the with-acceleration total required time Tta.

The fact that the reference total required time Ttc is longer than the with-deceleration total required time Ttd or the with-acceleration total required time Tta means that the travel speed needs to be decelerated or increased, so the process proceeds to step S17.

On the other hand, if the standard total required time Ttc is the shortest among the three types of total required times Tt, it means that the current travel speed setting is the setting for the shortest total required time Tt. In such case, there is no need to adjust the current travel speed setting, thereby the process returns to step S11.

In step S17, it is determined whether the reference total required time Ttc is longer than the with-deceleration total required time Ttd. In such case, when it is determined that the reference total required time Ttc is longer than the with-deceleration total required time Ttd, it means that the time required up to completion of charging at the charging station CS is shorter by performing the deceleration adjustment of the travel speed than traveling at the currently-set travel speed, the process proceeds to step S18.

On the other hand, when the reference total required time Ttc is not longer than the with-deceleration total required time Ttd, the process proceeds to step S19. As described above, in step S16, when the reference total required time Ttc is shorter than the with-deceleration total required time Ttd and the with-acceleration total required time Tta, the process is configured to return to step S11. Therefore, in the determination process of step S17, the case where the process proceeds to step S19 corresponds to the case where the reference total required time Ttc is longer than the with-acceleration total required time Tta.

In step S18, a travel speed decreasing process is performed because decelerating the travel speed from the currently-set travel speed will lead to a reduction in the total required time. In the travel speed decreasing process, the current travel speed setting is updated to the travel speed corresponding to the with-deceleration total required time Ttd. At this time, the target value regarding the travel control of the vehicle A is also updated, and notification regarding the newly-updated travel speed is also provided. When the travel speed decreasing process is completed, the process returns to step S11.

Then, in step S19, since increasing the travel speed from the currently-set travel speed will lead to a reduction in the total required time, a travel speed increasing process is performed. In the travel speed increasing process, the current travel speed setting is updated to the travel speed corresponding to the with-acceleration total required time Tta. At this time, the target value regarding the travel control of the vehicle A is also updated, and notification regarding the newly-updated travel speed is also provided. When the travel speed increasing process is completed, the process returns to step S11.

By repeating steps S11 to S19 of the battery management program, the energy manager 1 according to the second embodiment sets the travel speed from the current location to the charging station CS to an optimal setting that minimizes the total required time Tt.

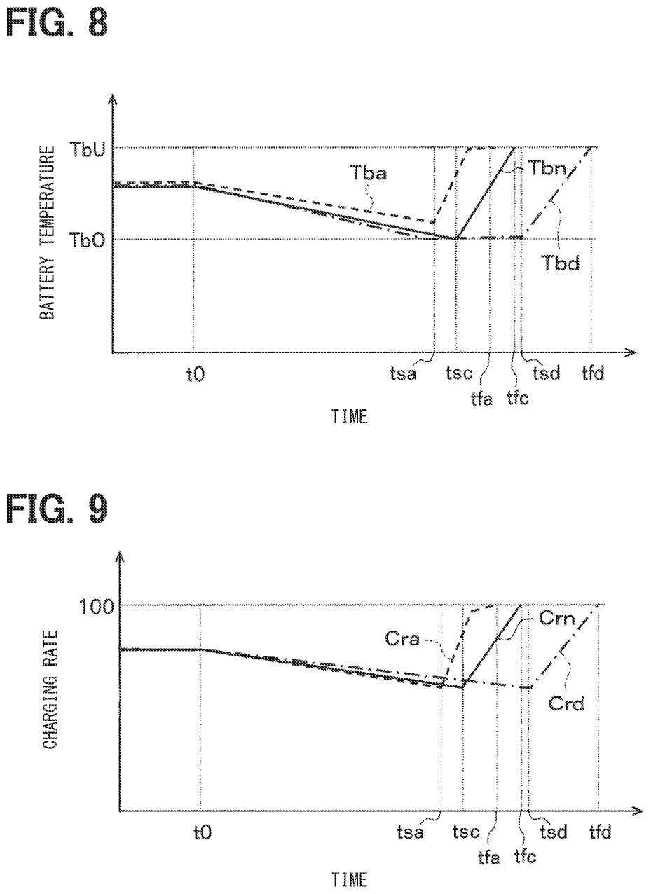

Next, the effects of the battery management program according to the second embodiment will be explained with reference to FIGS. 8 and 9. FIG. 8 shows an influence that the adjustment of the travel speed has on the change in the battery temperature Tb, and indicates the battery temperature when the travel speed is not adjusted as a reference battery temperature Tbn. Further, the battery temperature when the travel speed is adjusted to decelerate is indicated as a with-deceleration battery temperature Tbd, and the battery temperature when the travel speed is adjusted to increase is indicated as a with-acceleration battery temperature Tba.

FIG. 9 shows an influence that the adjustment of the travel speed has on the change in the charging rate, and shows the charging rate of the battery B when the travel speed is not adjusted as a reference charging rate Crn. In addition, the charging rate of the battery B when the travel speed is adjusted to decelerate is indicated as a with-deceleration charging rate Crd, and the charging rate of the battery B when the travel speed is adjusted to increase is indicated as a with-acceleration charging rate Cra.

Further, time t0, time tsc, time tsd, time tsa, time tfc, time tfd, and time tfa each indicate the same time in FIGS. 8 and 9. Time t0 indicates a start point of control by the battery management program according to the second embodiment.

First, changes in the battery temperature Tb and the charging rate of the battery B when the travel speed adjustment is not performed will be described. When control is started at time t0, the vehicle A travels to the charging station CS, and at the same time, the battery B is cooled by the temperature adjustment system 42.

At this time, the battery B self-generates heat due to the output caused by the travel of the vehicle A, and is cooled by the temperature adjustment system 42 at the same time, and the battery temperature Tb decreases as the vehicle A travels toward the charging station CS. As shown in FIG. 9, the charging rate of the battery B also decreases as the vehicle A travels toward the charging station CS, due to the output associated with the travel of the vehicle A and the output associated with the operation of the temperature adjustment system 42.

Time tsc indicates a point in time when the vehicle A arrives at the charging station CS and the charging at the charging station CS is started when the travel speed is not adjusted. In such case, the battery temperature at the arrival time has reached the target battery temperature TbO.

When the charging of the battery B at the charging station CS is started at time tsc, as shown in FIG. 9, the reference charging rate Crn increases. At this time, as shown in FIG. 8, due to the supply of charging current to the battery B and the internal resistance of the battery B, the reference battery temperature Tbn also rises as the charging time elapses.

At time tfc, the reference charging rate Crn when the travel speed is not adjusted becomes 100%, and the charging of the battery B at the charging station CS is completed. At time tfc, since the reference battery temperature Tbn is equal to or lower than the battery temperature upper limit value TbU, the charging time has been made as short as possible.

In the example shown in FIGS. 8 and 9, the charging time when the travel speed is not adjusted is shown as a period between time tsc and time tfc, and the reference total required time Ttc is shown as a period between time t0 and time tfc.

Next, changes in the battery temperature Tb and the charging rate of the battery B when the travel speed is adjusted to reduce the speed will be explained. When the control is started at time t0, the vehicle A travels to the charging station CS, and at the same time, the battery B is cooled by the temperature adjustment system 42, similarly to the case where the travel speed is not adjusted.

At this time, since the travel speed is adjusted to be decelerated and the load on the battery B is reduced, the degree of decrease of the with-deceleration battery temperature Tbd per unit time is greater than the one in the reference battery temperature Tbn. Therefore, the with-deceleration battery temperature Tbd reaches the target battery temperature TbO before arriving at the charging station CS. Thereafter, the operation of the temperature adjustment system 42 is controlled to maintain the target battery temperature TbO, to arrive at the charging station CS.

Time tsd is a time of arrival at the charging station CS when the travel speed has been adjusted to decelerate, and also means a time of starting charging of the battery B. In such case as well, the charging of the battery B at the charging station CS is started, and the with-deceleration charging rate Crd increases as time passes. At this time, as shown in FIG. 9, due to the supply of the charging current to the battery B and the internal resistance of the battery B, the with-deceleration battery temperature Tbd also rises as the charging time passes.

Since the battery temperature at the arrival time is the target battery temperature TbO, the capacity of the charging station CS is fully utilized without being subject to charging current limitations caused by the battery temperature Tb reaching the battery temperature upper limit value TbU, for the charging of the battery B.

Time tfd indicates a point in time when the charging of the battery B is completed in case that the travel speed is adjusted to decelerate. As shown in FIGS. 8 and 9, the with-deceleration charging rate Crd at time tfd is 100%, and the with-deceleration battery temperature Tbd is less than the battery temperature upper limit value TbU.

In the example shown in FIGS. 8 and 9, the charging time when the travel speed is adjusted to decelerate is shown as a period between time tsd and time tfd, and the with-deceleration total required time Ttd is shown as a period from time t0 to time tfd.

Next, changes in the battery temperature Tb and the charging rate of the battery B when the travel speed is adjusted to increase will be explained. When the control is started at time t0, the vehicle A travels to the charging station CS, and at the same time, the battery B is cooled by the temperature adjustment system 42, similarly to the case where the travel speed is not adjusted.

At this time, since the travel speed is adjusted to increase, and the load on the battery B is increased, the degree of decrease per unit time of the with-acceleration battery temperature Tba is lower than the one in the reference battery temperature Tbn and the one in the with-deceleration battery temperature Tbd. In addition, by adjusting the travel speed to increase the speed, the time required from the current location to the charging station CS is reduced, thereby the vehicle A arrives at the charging station CS before the with-acceleration battery temperature Tba is cooled to the target battery temperature TbO.

Time tsa is a time of arrival at the charging station CS when the travel speed is adjusted to increase, and also means a time of starting the charging of the battery B. In such case as well, the charging of the battery B at the charging station CS is started, and the with-acceleration charging rate Cra rises as time passes. At this time, as shown in FIG. 9, due to the supply of the charging current to the battery B and the internal resistance of the battery B, the with-acceleration battery temperature Tba also rises as the charging time passes.

Here, when the travel speed is adjusted to increase, the battery temperature at the arrival time is higher than the target battery temperature TbO. Therefore, when the with-acceleration battery temperature Tba rises as the battery B is charged at the charging station CS, the battery temperature upper limit value TbU is reached before the with-acceleration charging rate Cra reaches 100%.

At the point in time when the with-acceleration battery temperature Tba reaches the battery temperature upper limit value TbU, the charging current supplied to the battery B is limited at the charging station CS. Therefore, as shown in FIG. 9, the amount of increase per unit time in the with-acceleration charging rate Cra becomes gentler at a time when the with-acceleration battery temperature Tba reaches the battery temperature upper limit value TbU. As a result of the charging of the battery B with the limited charging current, when the with-acceleration charging rate Cra reaches 100%, the charging of the battery B in such case is completed. In FIGS. 8 and 9, such a point in time is indicated as time tfa.

Thus, the charging time when the travel speed is adjusted to increase is shown as a period from time tsa to time tfa, and the with-acceleration total required time Tta is shown as a period from time t0 to time tfa.

In the example shown in FIGS. 8 and 9, the required time from the current location to the charging station CS is shortest when the travel speed is adjusted to increase. Further, when comparing the time points at which the charging of the battery B is completed in three cases, it can be seen that the time points are in an order of time tfa, time tfc, and time tfd. That is, in the example shown in FIGS. 8 and 9, the travel to the charging station CS and the charging of the battery B can be completed most quickly when the travel speed from the current location to the charging station CS is increased.

As explained above, according to the energy manager 1 in the second embodiment, by estimating the total required time Tt when various travel speed adjustments are made by using the environmental information and by comparing the estimation results, the adjustment of the travel speed for achieving the shortest time up to completion of the charging is realized. In addition, in the second embodiment, in addition to deceleration adjustment, acceleration adjustment is also performable as a mode of adjusting the travel speed, thereby the period up to completion of the charging of the battery B is reducible in a more appropriate manner.

### Third Embodiment

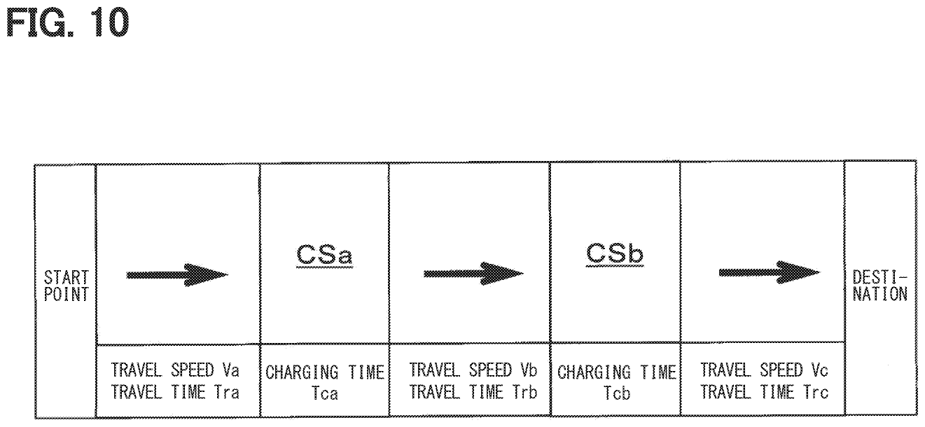

Next, portions of the third embodiment, different from the above-described embodiments, will be mainly described with reference to FIGS. 10 to 12. In the third embodiment, a case will be described in which the processing contents described in the above embodiments are applied to a situation where a plurality of charging stations CS are arranged on a travel route. The basic configuration of the energy manager 1 and the like in the third embodiment is the same as in the embodiments described above.

When a plurality of charging stations CS exist on the travel route, the energy manager 1 adjusts the travel speed using the estimation result of the total required time Tt in the embodiments described above, and considers operation patterns including whether or not the charging is performed at each of the charging stations CS.

In the following description, an example will be given in which there are two charging stations CS, i.e., a first charging station CSa and a second charging station CSb, on the travel route from a start point to a destination, with reference to FIGS. 10 to 12.

In the case of the above-described specific example, since the first charging station CSa and the second charging station CSb are present on the travel route, three types of operation patterns, the first to third operation patterns, are conceivable.

The first operation pattern refers to an operation pattern of the vehicle A when the battery B is charged at both of the first charging station CSa and the second charging station CSb on its way from the start point to the destination. The second operation pattern is an operation pattern of the vehicle A in which the battery B is charged at the first charging station CSa and the vehicle A passes through the second charging station CSb on its way from the start point to the destination. The third operation pattern is an operation pattern in which the vehicle A passes through the first charging station CSa and charges the battery B at the second charging station CSb on its way from the start point to the destination.

Next, a case in which the above-described processing contents are applied to each of the operation patterns will be described with reference to the drawings. First, a case in which the above-described processing contents are applied to the first operation pattern will be described with reference to FIG. 10.

As shown in FIG. 10, in the first operation pattern, charging is performed at the first charging station CSa and at the second charging station CSb. Therefore, first, the required time for traveling from the start point to the first charging station CSa and the charging time at the first charging station CSa are estimated by applying the processing contents according to the second embodiment described above.

By setting the start point to the current location and applying the processing contents according to the second embodiment, a travel speed Va is estimated as an optimal travel speed from the start point to the first charging station CSa, and a travel time Tra is estimated as the required time for traveling at the travel speed Va. Also, using the environmental information, it is possible to estimate the arrival time situation when traveling from the start point to the first charging station CSa at the travel speed Va, thereby a charging time Tca of the battery B at the first charging station CSa can be estimated.

Next, the required time for traveling from the first charging station CSa to the second charging station and the charging time at the second charging station CSb are estimated by applying the processing contents according to the embodiment described above.

By setting the first charging station CSa as the current location in the process and applying the processing contents according to the second embodiment, a travel speed Vb is estimated as an optimal travel speed from the first charging station CSa to the second charging station CSb. Then, a travel time Trb is estimated as the required time when traveling at the travel speed Vb. Further, by using the environmental information, it is possible to estimate the arrival time situation when traveling from the first charging station CSa to the second charging station CSb at the travel speed Vb, thereby a charging time Tcb of the battery B at the second charging station CSb can be estimated.

Next, by setting the second charging station CSb as the current location in the process and applying the processing contents according to the second embodiment, a travel speed Vc is estimated as an optimal travel speed from the second charging station CSb to the destination. Further, a travel time Trc is estimated as the required time when traveling at the travel speed Vc.

Thus, the total required time Tt related to the first operation pattern is obtained by adding the travel time Tra, the charging time Tca, the travel time Trb, the charging time Tcb, and the travel time Trc.

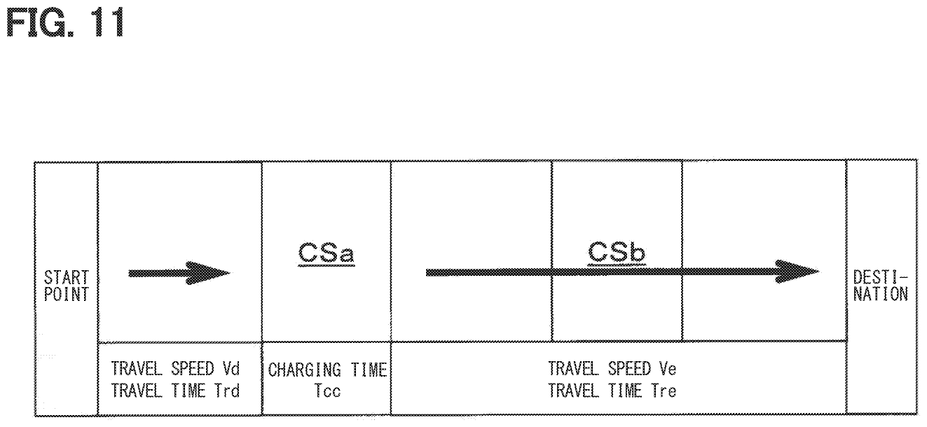

Next, a case in which the above-described processing contents are applied to the second operation pattern will be described with reference to FIG. 11. As shown in FIG. 11, in the second operation pattern, the battery B is charged at the first charging station CSa, and the vehicle A passes through the second charging station CSb without charging the battery B.

First, the required time for traveling from the start point to the first charging station CSa and the charging time at the first charging station CSa are estimated by applying the processing contents according to the second embodiment described above.

By setting the start point to the current location and applying the processing contents according to the second embodiment, a travel speed Vd is estimated as an optimal travel speed from the start point to the first charging station CSa, and a travel time Trd is estimated as the required time for traveling at the travel speed Vd. Also, using the environmental information, it is possible to estimate the arrival time situation when traveling from the start point to the first charging station CSa at the travel speed Vd, thereby a charging time Tcc of the battery B at the first charging station CSa can be estimated.

Here, in the second operation pattern, since the vehicle passes through the second charging station CSb, the required time for traveling from the first charging station CSa to the destination is estimated by applying the processing contents according to the embodiment described above.

By setting the first charging station CSa as the current location in the process and applying the processing contents according to the second embodiment, a travel speed Ve is estimated as an optimal travel speed from the first charging station CSa to the destination. Then, a travel time Tre is estimated as the required time when traveling at the travel speed Ve.

Therefore, the total required time Tt related to the second operation pattern is obtained by adding the travel time Trd from the start point to the first charging station CSa, the charging time Tcc at the first charging station CSa, and the travel time Tre from the first charging station CSa to the destination.

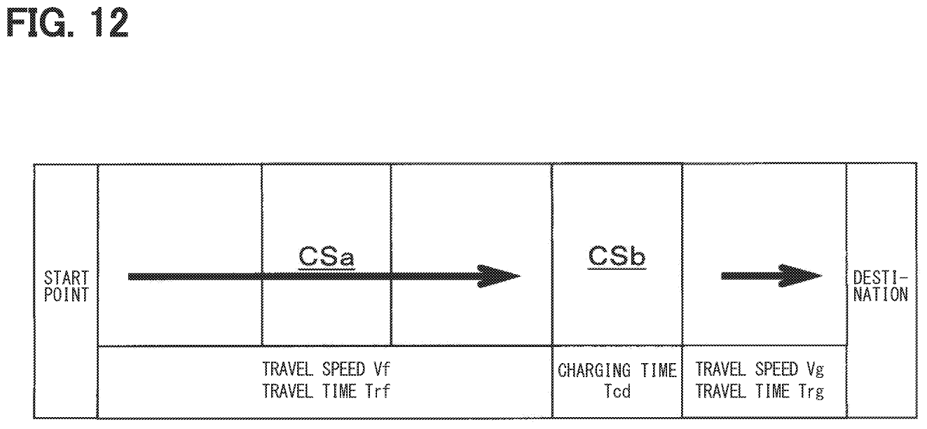

Next, a case in which the above-described processing contents are applied to the third operation pattern will be described with reference to FIG. 12. As shown in FIG. 12, in the third operation pattern, the vehicle A passes through the first charging station CSa without charging the battery B, and the battery B is charged at the second charging station CSb.

Thus, the required time for traveling from the start point to the second charging station CSb and the charging time at the second charging station CSb are estimated by applying the processing contents according to the second embodiment described above. By setting the start point to the current location and applying the processing contents according to the second embodiment, a travel speed Vf is estimated as an optimal travel speed from the start point to the second charging station CSb, and a travel time Trf is estimated as the required time for traveling at the travel speed Vf.

By using the environmental information, it is possible to estimate the arrival time situation when traveling from the start point to the second charging station CSb at the travel speed Vf, thereby a charging time Tcd of the battery B at the second charging station CSb can be estimated.

Then, by setting the second charging station CSb as the current location in the process and applying the processing contents according to the second embodiment, a travel speed Vg is estimated as an optimal travel speed from the second charging station CSb to the destination. Then, a travel time Trg is estimated as the required time when traveling at the travel speed Vg.

Thus, the total required time Tt related to the third operation pattern is obtained by adding the travel time Trf from the start point to the second charging station CSb, the charging time Tcd at the second charging station CSb, and the travel time Trg from the second charging station CSb to the destination.

As shown in FIGS. 10 to 12, it is possible to estimate the total required times for the first to third operation patterns, thereby it is possible to identify an operation pattern of the vehicle A that has the shortest total required time when there are multiple charging stations CS on the travel route. As a result, it is possible to understand at which charging station CS to charge during a travel along the travel route from the start point to the destination will contribute to (i) reducing the total travel time and (ii) reducing the time to arrive at the destination, thereby enabling an efficient operation of the vehicle A and the battery B.

In the specific example described above, the first charging station CSa and the second charging station CSb are present on the travel route from the start point to the destination. However, the configuration is not limited to such embodiment. The number of charging facilities (charging stations CS) existing on the travel route may be two or more.

As explained above, according to the energy manager 1 according to the third embodiment, it is possible to estimate the total required time Tt even when there are multiple charging stations CS on the travel route from the start point to the destination. Since it is possible to consider multiple patterns of driving modes of the vehicle A, it is possible to select the charging station CS for charging the battery B for achieving the shortest total required time.

The present disclosure is not limited to the embodiments described above, and various modifications can be made as follows within a range not departing from the spirit of the present disclosure.

In the embodiment described above, an example in which the energy manager 1 is applied as a battery management device has been described. However, the present disclosure is not limited to such embodiment. For example, in the embodiment described above, since the battery management program is executed in the energy manager 1, which is an in-vehicle computer, the technical idea according to the present disclosure can be understood as a battery management program. Further, the technical idea according to the present disclosure can also be understood as a battery management method.

Further, in the embodiment described above, the temperature adjustment system 42 is employed as an example of the temperature adjustment unit. However, the present disclosure is not limited to such embodiment. As the temperature adjustment unit, various units and methods can be adopted as long as the device or system is capable of adjusting the temperature of the battery B.

In the first embodiment described above, the explanation focused on cooling the battery as a mode of temperature adjustment. However, it is also possible to configure the battery B to be warmed up (heated).

Further, the charging plan in the present disclosure only needs to determine at least the charging facility (charging station CS) that will be used to charge the battery B when the vehicle A travels toward the destination in the future, and thereby it is sufficient that at least the location information of the charging facility is included in the environmental information. As in the above-described embodiment, a mode in which a travel route along which the vehicle A will travel in the future toward a destination and a charging facility (charging station CS) arranged on the travel route are determined also corresponds to an example of a charging plan.

Further, when the environmental information is composed of position information of a charging facility used to charge the battery B, the following processing can be performed. For example, the arrival time of the vehicle A to the charging facility can be estimated by specifying a distance from the current location to the charging facility using the location information of the charging facility, and by dividing it by the travel speed (for example, legal speed). In such manner, by estimating the arrival time of the vehicle A to the charging facility, it is possible to perform the processes of step S1 and step S11 of the above-described embodiment.

Although the present disclosure has been described according to the embodiments, it is understood that the present disclosure is not limited to the above-described embodiments or structures. The present disclosure incorporates various modifications and variations within the scope of equivalents. In addition, various combinations and forms, and other combinations and forms including one more/less element, more than one or less than one elements added/subtracted to/from such combinations and forms are also included in the scope and concept of the present disclosure.

What is claimed is:

1. A battery management device configured to manage a state of a battery that is mounted on a vehicle for driving the vehicle, the battery management device comprising:
a temperature adjustment unit configured to perform a temperature adjustment of the battery;
an environmental information acquisition unit configured to acquire environmental information including information on a charging facility capable of charging the battery based on a charging plan regarding a travel of the vehicle toward a destination in a future;
a temperature estimation unit configured to estimate a temperature of the battery when the vehicle arrives at the charging facility based on the environmental information acquired by the environmental information acquisition unit;
a target temperature setting unit configured to set a target temperature of the battery, at which an efficient charging of the battery is performable when the vehicle travels and arrives at the charging facility while operating the temperature adjustment unit; and
a travel speed adjustment unit configured to determine an adjustment amount of a travel speed when the vehicle travels to the charging facility by using an estimated temperature of the battery estimated by the temperature estimation unit and the target temperature of the battery set by the target temperature setting unit.

2. The battery management device according to claim 1, wherein the travel speed adjustment unit determines the adjustment amount of the travel speed of the vehicle in accordance with a difference between the estimated temperature of the battery estimated by the temperature estimation unit and the target temperature of the battery set by the target temperature setting unit.

3. The battery management device according to claim 1, further comprising:
a required time estimation unit configured to estimate a required time for which the vehicle arrives to the charging facility when the vehicle travels while operating the temperature adjustment unit, based on the environmental information acquired by the environmental information acquisition unit,
wherein the travel speed adjustment unit determines the adjustment amount of the travel speed of the vehicle when the vehicle travels to the charging facility, by using (i) a deviation of a current temperature of the battery from the target temperature of the battery set by the target temperature setting unit and (ii) the required time estimated by the required time estimation unit.

4. The battery management device according to claim 3, wherein
the travel speed adjustment unit adjusts the travel speed of the vehicle to have a greater decrease in the travel speed of the vehicle as the required time estimated by the required time estimation unit becomes shorter.

5. The battery management device according to claim 3, wherein
the travel speed adjustment unit adjusts the travel speed of the vehicle to have a greater decrease in the travel speed of the vehicle as the deviation of the current temperature of the battery from the target temperature of the battery set by the target temperature setting unit becomes larger.

6. The battery management device according to claim 3, wherein
the required time estimation unit estimates (i) the required time in accordance with the current travel speed of the vehicle and (ii) the required time based on an adjusted travel speed, with respect to the required time of the travel to arrive at the charging facility while operating the temperature adjustment unit, the battery management device further comprising:
a charging time estimation unit configured to estimate (i) a charging time at the charging facility when the vehicle travels at the current travel speed and (ii) a charging time at the charging facility when the vehicle travels at the adjusted travel speed; and
a total time estimation unit configured to estimate (i) a total time that is a total of the required time of the travel at the current travel speed and the charging time, and (ii) a total time that is a total of the required time of the travel at the adjusted travel speed, and
the travel speed adjustment unit determines the adjustment amount of the travel speed of the vehicle for traveling to the charging facility, and the total time with the travel at the adjusted travel speed is shorter than the total time with the travel at the current travel speed.

7. The battery management device according to claim 6, wherein
the total time estimation unit estimates the total time for each of the charging facilities when a plurality of charging facilities are arranged along a travel route that is determined as the charging plan, and
the travel speed adjustment unit selects the charging facility and adjusts the travel speed to have a shortest destination arrival time of the travel of the vehicle, by using an estimation result of the total time obtained by the total time estimation unit.

8. The battery management device according to claim 1, further comprising:
an information transmission unit configured to transmit information to an occupant of the vehicle,
wherein the travel speed adjustment unit outputs an adjustment result in connection with the travel speed of the vehicle to the information transmission unit.

9. The battery management device according to claim 1, wherein
the travel speed adjustment unit sets an adjustment result in connection with the travel speed of the vehicle, as a target value of controlling the travel speed of the vehicle.

10. The battery management device according to claim 1, further comprising:
a capacity adjustment unit configured to adjust a temperature control capacity of the temperature adjustment unit while the vehicle travels so as to achieve the target temperature of the battery when the vehicle arrives at the charging facility, in a case where (i) a condition for adjusting the travel speed of the vehicle by the travel speed adjustment unit is satisfied and (ii) the temperature control capacity of the temperature adjustment unit is adjustable.

11. A battery management device configured to manage a state of a battery that is mounted on a vehicle to drive the vehicle, the battery management device comprising
at least one of a circuit and a processor having a memory storing computer program code, wherein the at least one of the circuit and the processor having the memory is configured to cause the device to:
perform a temperature adjustment of the battery;
acquire environmental information including information on a charging facility capable of charging the battery based on a charging plan in connection with a travel of the vehicle toward a destination in a future;
estimate a temperature of the battery when the vehicle arrives at the charging facility based on the environmental information from the environmental information acquisition unit;
set a target temperature of the battery, at which an efficient charging of the battery is performable when the vehicle travels and arrives at the charging facility while operating the temperature adjustment unit; and
determine an adjustment amount of a travel speed when the vehicle travels to the charging facility, by using an estimated temperature of the battery estimated by the temperature estimation unit and the target temperature of the battery set by the target temperature setting unit.
